(19) United States
(12) Patent Application Publication
(10) Pub. No.: US 2014/0221737 A1
(43) Pub. Date: Aug. 7, 2014

(54) VIBRATING DEVICE

(71) Applicant: Ozaki International Co., Ltd., New Taipei City (TW)

(72) Inventor: Keng-Yuan LIU, New Taipei City (TW)

(73) Assignee: Ozaki International Co., Ltd., New Taipei City (TW)

(21) Appl. No.: 14/085,089

(22) Filed: Nov. 20, 2013

(30) Foreign Application Priority Data
Feb. 6, 2013 (TW) 102202617
Sep. 11, 2013 (TW) 102217110

(51) Int. Cl. A61H 19/00

(52) U.S. Cl. CPC A61H 19/44
USPC 600/38

(57) ABSTRACT

A vibrating device is provided, and includes a base body and a plurality of extending members. A vibrating motor is assembled in the base body. Each extending member is formed as elongated shape and includes a shaping portion and a connecting portion. The connecting portion of each extending member has a receiving groove so as to detachably connect with the base body.

### CROSS-REFERENCES TO RELATED APPLICATIONS

This non-provisional application claims priority under 35 U.S.C. §119(a) on Patent Application No. 102202617 filed in Taiwan, R.O.C. on Feb. 6, 2013 and Patent Application No. 102217110 filed in Taiwan, R.O.C. on Sep. 11, 2013, the entire contents of which are hereby incorporated by reference.

### BACKGROUND OF THE INVENTION

1. Technical Field

The present invention relates to a vibrating device, and particularly to a vibrating device in which the accessories thereof can be alternated.

2. Related Art

The requirement of sex is one of the basic necessities for a human being. Once an adult can find an appropriate partner, their requirement of sex can be satisfied. However, even if someone does not have a partner, he/she still has to solve the problem about satisfying the requirement of sex; otherwise, they can be uncomfortable or even become a sexual offender because of the unsatisfied requirement of sex. Moreover, as the breakthrough developments of people's thoughts, couples sometimes may use the adult toys to improve the sexual comfortableness for releasing unwanted emotions.

Therefore, various adult toys are appeared to the market, so that the requirements of sex can be satisfied for both the male users and the female users by the adult toys; thereby reducing the risk of infecting venereal diseases and sexually transmitted viruses. Further, the motivation and the possibility for becoming an sexual offender for a human being are reduced as well. Even for those people who have boyfriends/girlfriends, the application of the adult toys during sex may improve the qualities of the sex and provides comfortableness for both the man and the woman.

The adult toys can be roughly divided according to gender. Particularly, one of the adult toys for females is the massage vibrator. A conventional massage vibrator has a massage at a front portion thereof, so that the massage unit of the conventional massage vibrator which like the outline of a penis is inserted in to the user's vagina and massages the user's private so as to provide pleasure for the user. However, the conventional massage vibrator is as one piece, so that the user cannot freely change the massage unit with another to provide different feelings upon massaging.

### SUMMARY

In view of this, the present invention proposes a vibrating device to resolve the aforementioned problem about the massage vibrators having the same shape.

According to one invention concept of the present invention, a vibrating device includes a base body and a first extending member. The base body has a vibrating motor assembled therein. The first extending member is approximately formed as elongated shape and includes a first shaping portion and a first connecting portion. The first shaping portion and the first connecting portion are disposed at two ends of the major axis of the first extending member respectively. The first connecting portion has a receiving groove formed by recessing the first connecting portion in a direction toward the first shaping portion. The receiving groove is sleeved onto one end of the base body.

According to another invention concept of the present invention, a vibrating device includes a base body and a second extending member. The second extending member includes a second shaping portion and a second connecting portion, in which the second shaping portion is disposed opposite to the second connecting portion. The second connecting portion of the second extending member is detachably connected to the base body. One end-face of the base body and another end-face of the second connecting portion have the same size and the same shape, in which one end-face of the base body and another end-face of the second connecting portion contacts with each other.

According to a further invention concept of the present invention, a vibrating device includes a base body, a first extending member and a second extending member. The base body includes a first sleeving end and a second sleeving end opposite to the first sleeving end. The base body has a vibrating motor assembled therein. The first extending member is approximately formed as elongated shape and includes a first shaping portion and a first connecting portion. The first shaping portion and the first connecting portion are disposed at two ends of the major axis of the first extending member. The first connecting portion has a first receiving groove formed by recessing the first connecting portion in a direction toward the first shaping portion. The second extending member is also approximately formed as elongated shape and includes a second shaping portion and a second connecting portion. The second shaping portion and the second connecting portion are respectively disposed at two ends of the major axis of the second extending member. The second connecting portion has a second receiving groove formed by recessing the second connecting portion in a direction toward the second shaping portion. The first extending member is sleeved onto the first sleeving end of the base body and the second extending member is sleeved onto the second sleeving end of the base body, such that the first sleeving end of the base body is enclosed by the first extending member and the second sleeving end of the base body is enclosed by the second extending member respectively.

Based on the above, the detachable first extending member and/or the detachable second extending member are selectively connected with the base body of the vibrating device; or, alternatively, the first extending member and/or the second extending member can sleeved onto the base body so as to provide different feelings for the user.

The detailed features and advantages of the present invention are described below in great detail through the following embodiments, the content of the detailed description is sufficient for those skilled in the art to understand the technical content of the present invention and to implement the present invention there accordingly. Based on the content of the specification, the claims, and the drawings, those skilled in the art can easily understand the relevant objectives and advantages of the present invention.

### BRIEF DESCRIPTION OF THE DRAWINGS

The present invention will become more fully understood from the detailed description given herein below for illustration only, and thus are not limitative of the present invention, and wherein:

FIG. 1A is an exploded view (1) of a vibrating device of a first embodiment of the present invention;

FIG. 1B is a perspective view of the vibrating device of the first embodiment of the present invention;

FIG. 2 is an operating schematic view of the vibrating device of the first embodiment of the present invention;

FIG. 3A is a perspective view (2) of the vibrating device of the first embodiment of the present invention;

FIG. 3B is a perspective view of the vibrating device of the first embodiment of the present invention;

FIG. 3C is a perspective view (4) of the vibrating device of the first embodiment of the present invention;

FIG. 3D is a perspective view (5) of the vibrating device of the first embodiment of he present invention;

FIG. 3E is a perspective view (6) of the vibrating device of the first embodiment of the present invention;

FIG. 4A is an exploded view (1) of a vibrating device of a second embodiment of the present invention;

FIG. 4B is a perspective view (1) of the vibrating device of the second embodiment of the present invention;

FIG. 5A is a perspective view (2) of the vibrating device of the second embodiment of the present invention;

FIG. 5B is a perspective view (3) of the vibrating device of the second embodiment of the present invention;

FIG. 5C is a perspective view (4) of the vibrating device of the second embodiment of the present invention.;

FIG. 5D is a perspective view (5) of the vibrating device of the second embodiment of the present invention;

FIG. 6A is an exploded view (1) of a vibrating device of a third embodiment of the present invention;

FIG. 6B is a perspective view (1) of the vibrating device of the third embodiment of the present invention;

FIG. 7A is a perspective view (2) of the vibrating device of the third embodiment of the present invention;

FIG. 7B is a perspective view (3) of the vibrating device of the third embodiment of the present invention;

FIG. 7C is a perspective view (4) of the vibrating device of the third embodiment of the present invention;

FIG. 7D is a perspective view (5) of the vibrating device of the third embodiment of the present invention;

FIG. 8A is an exploded view of a vibrating device of a fourth embodiment of he present invention;

FIG. 8B is a perspective view (1) of the vibrating device of the fourth embodiment of the present invention;

FIG. 9 is an operating schematic view o vibrating device of the fourth embodiment of the present invention;

FIG. 10A is a cross-sectional view (1) of the vibrating device of the fourth embodiment of the present invention;

FIG. 10B is a cross-sectional (2) of the vibrating device of the fourth embodiment of the present invention;

FIG. 11 is a perspective view (2) of the vibrating device of the fourth embodiment of the present invention;

FIG. 12 is a perspective view (3) of the vibrating device of the fourth embodiment of the present invention;

FIG. 13 is a perspective view (4) of the vibrating device of the fourth embodiment of the present invention;

FIG. 14 is a perspective view (5) of the vibrating device of the fourth embodiment of the present invention;

FIG. 15A is a perspective view (6) of the vibrating device of the fourth embodiment of the present invention;

FIG. 15B is a cross-sectional view of the vibrating device of the fourth embodiment of the present invention;

FIG. 16 is a perspective view (7) of the vibrating device of the fourth embodiment of the present invention;

FIG. 17 is a perspective view of a vibrating device of a fifth embodiment of the present invention in which the vibrating device has recessed grooves;

FIG. 18A is an enlarged cross-sectional (1) along line A-A′ shown in FIG. 17;

FIG. 18B is an enlarged cross-sectional view (2) along line A-A′ shown in FIG. 17; and

FIG. 18C is an enlarged cross-sectional view (3) along line A-A′ shown in FIG. 17.

### DETAILED DESCRIPTION

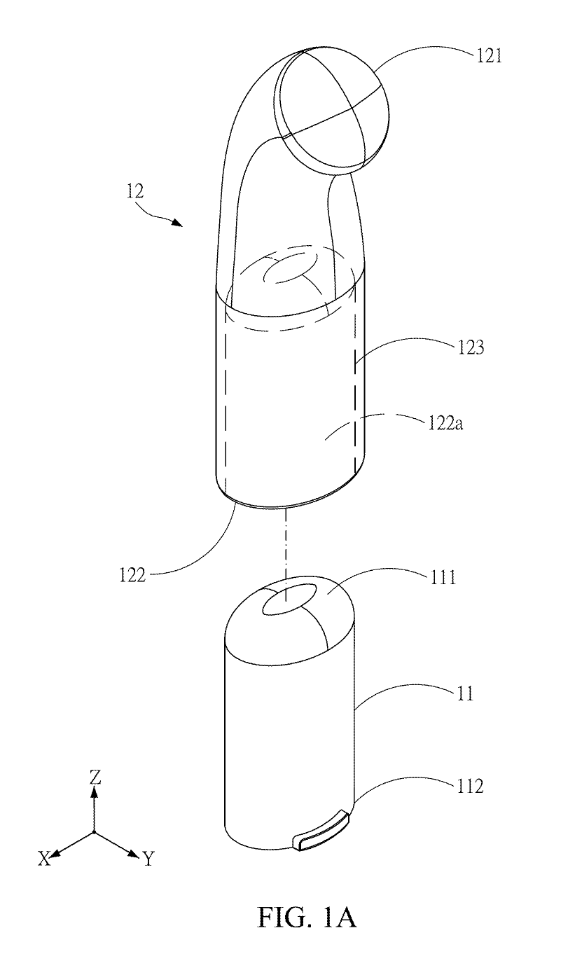

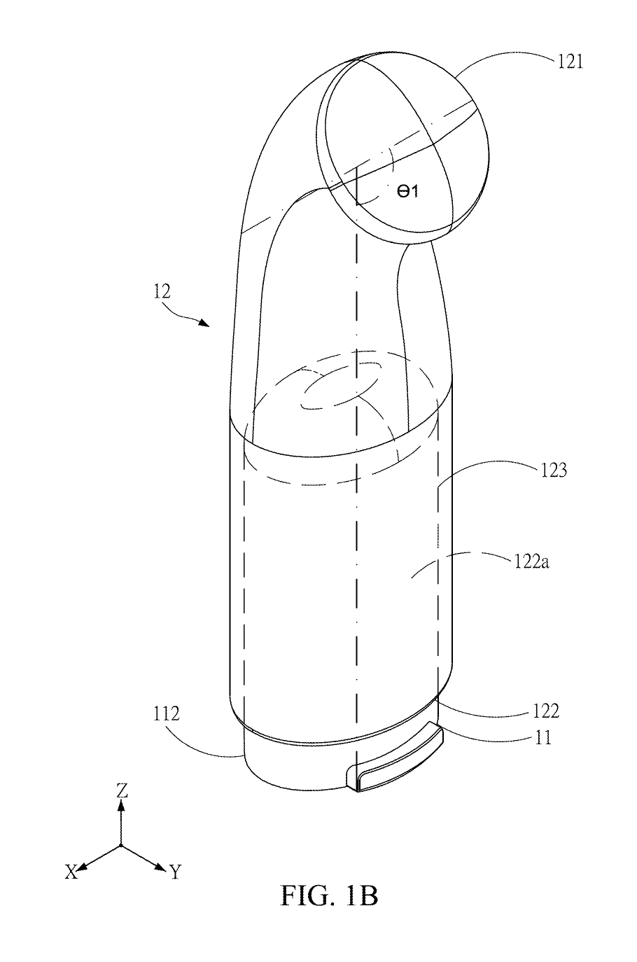

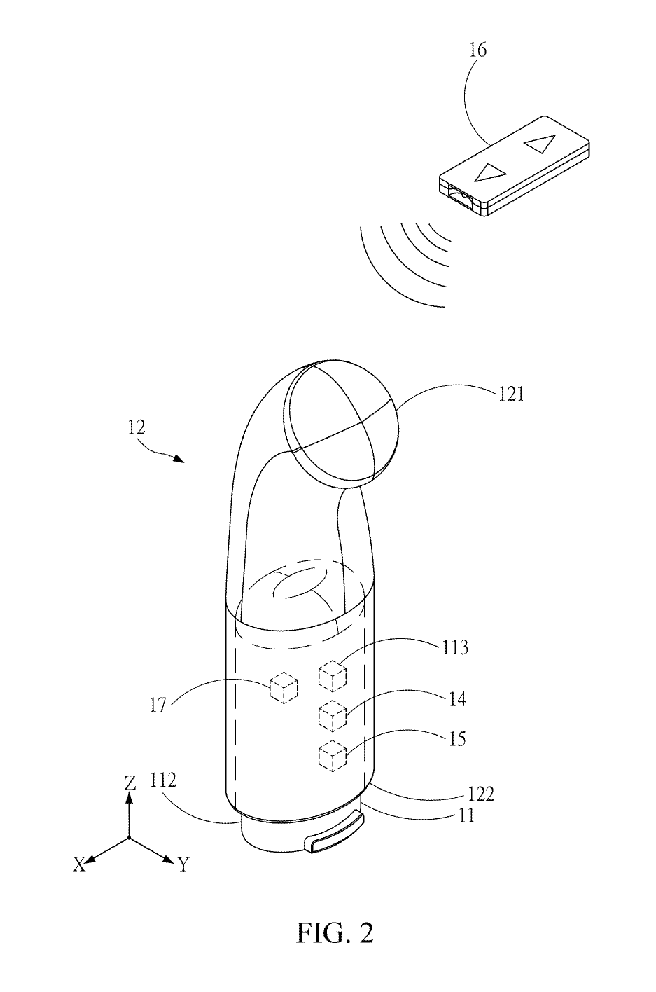

FIG. 1A is an exploded view (1) of a vibrating device of a first embodiment of the present invention. FIG. 1B is a perspective view (1) of the vibrating device of the first embodiment of the present invention. FIG. 2 is an operating schematic view of the vibrating device of the first embodiment of the present invention.

Please refer to FIG. 1A, FIG. 1B and FIG. 2, the vibrating device includes a base body 11 and a first extending member 12. As shown in FIG. 2, the base body 11 has a vibrating motor 113 assembled therein. As shown in FIG. 1A, the first extending member 12 is approximately formed as elongated shape in this embodiment. The first extending member 12 can be a rod shaped structure, an elliptic-cylinder shaped structure or an egg shaped structure, but embodiments of the present invention are not limited thereto. The first extending member 12 includes a first shaping portion 121, a first connecting portion 122 and a first rod portion 123. Two ends of the first rod portion 123 are respectively connected to the first shaping portion 121 and the first connecting portion 122. In other words, the first shaping portion 121 and the first connecting portion 122 are respectively disposed at two ends of the major axis of the first extending member 12. The first connecting portion 122 has a receiving groove 122a which is formed by recessing the first connecting portion 122 in a direction toward the first shaping portion 121. That is to say, the opening direction of the receiving groove 122a is far from the first shaping portion 121. As shown in FIG. 1B, the receiving groove 122a is sleeved onto one end of the base body 11, so that the first extending member 12 is sleeved onto a first end 111 of the base body 11 via the receiving groove 122a. Based on this, the vibration generated from the vibrating motor 113 is delivered to the first extending member 12, so that the first extending member 12 is vibrated along with the vibration of the vibrating motor 113.

In one embodiment, the base body 11 is formed as a cuboid or an elliptical cylinder, and the edges and the corners of the base body 11 are chamfered so as to be smooth, but embodiments of the present invention are not limited thereto. As shown in FIG. 1A, one end of the first shaping portion 121 is an arc curved surface.

The base body 11 includes a shell which is made of metals, tempered glass, or other rigid materials. The vibrating motor 113 is assembled in the shell. The first extending member 12 is made of elastic polymeric materials, such as silica gel or latex, but embodiments of the present invention are not limited thereto.

In an implementation aspect, the receiving volume of the receiving groove 122a is smaller than the volume of the base body 11, so that parts of the base body 11 is exposed out from the receiving groove 122a and formed as a handle-like structure for holding.

In an implementation aspect, the receiving volume of the receiving groove 122a is equal to the volume of the base body 11, so that the base body 11 is completely received in the receiving groove 122a. Here, the first extending member 12 is an egg shaped structure.

As shown in FIGS. 1A-1B, since the first extending member 12 is made of elastic materials, the opening of the receiving groove 122a can be expanded by the base body 11, so that the base body 11 is sleeved into the receiving groove 122a and is closely combined with the first extending member 12.

In one embodiment, as shown in FIG. 1B, the first shaping portion 121 is a bending segment and the bending angle of the first shaping portion 121 is a first included angle θ₁ such that the outline of the first shaping portion 121 is ergonomic. The first included angle θ₁ is defined in a range between 90 and 180 degrees; preferably, the first included angle θ₁ is defined in a range between 100 and 150 degrees; for example, the first included angle θ₁ is 135 degrees.

As shown in FIG. 2, the vibrating device further includes a power supply 14, a control module 15 and a heating module 17. The power supply 14, the control module 15 and the heating module 17 are assembled in the base body 11 and are electrically connected with each other. Further, the power supply 14 and the control module 15 are capable of electrically connected with the vibrating motor 113. Here, the power supply 14 is a rechargeable battery (such as a nickel-metal hydride battery or a lithium battery), or a non-rechargeable battery (such as an alkaline battery), but embodiments of the present invention are not limited thereto,

In one embodiment, the vibrating device receives an outer electrical source (such as supply mains, power device with a USB interface, etc).

As shown in FIG. 2, the control module 15 receives a control signal from an outer remote-control module 16, so that the vibrating frequency and the vibrating intensity of the vibrating motor 113 are adjusted according to, the control signal. Here, the control module 15 substantially includes a micro control member and a first communication unit, and the remote-control module 16 includes a second communication unit. Both the first communication unit and the second communication unit can be substantially embodied via communication chips and communication circuits. The control signal can be transmitted via wire transmission (such as USB), or wireless transmission (such as infrared or Bluetooth).

The heating module 17 receives electricity from the power supply 14 and is heated via the controlling of the control module 15 so as to increase the temperature of the shell of the base body 11. In some embodiments, the first extending member 12 (or the second extending member 13) has a plurality of heat conducted portions extended longitudinally on the inner surface thereof. One ends of the heat conducted portions contact with the shell of the base body 11, so that the heat on the base body 11 is transmitted to the other ends of the heat conducted portions. Based on this, the first shaping portion 121 of the first extending member (or a second shaping portion of a second extending member), receives the heat from the heat conducted portions, so that the temperature of the surface of the first extending member (or the second extending member), is increased so as to enhance the comfortableness for the user.

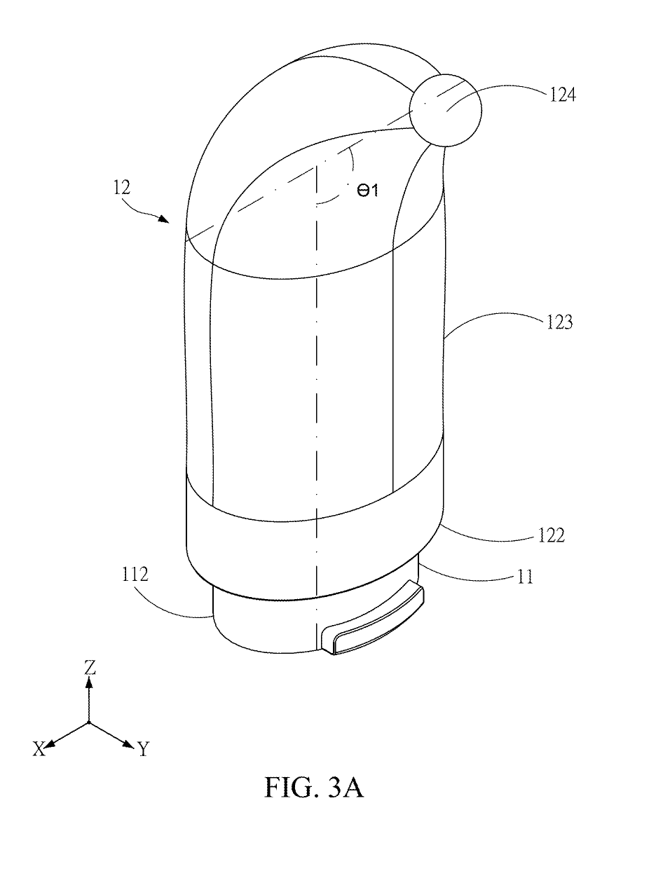

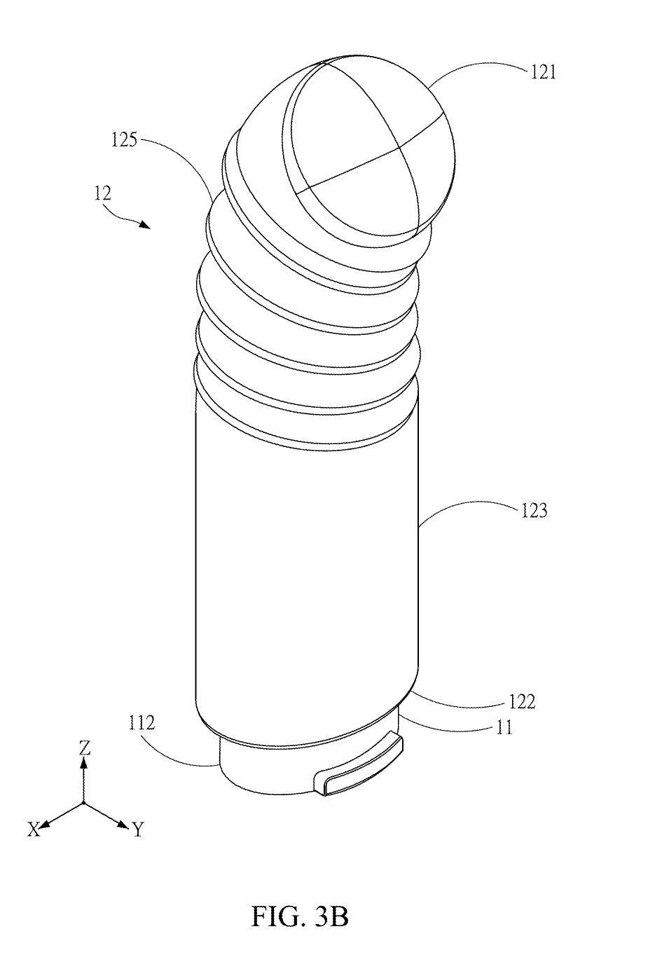

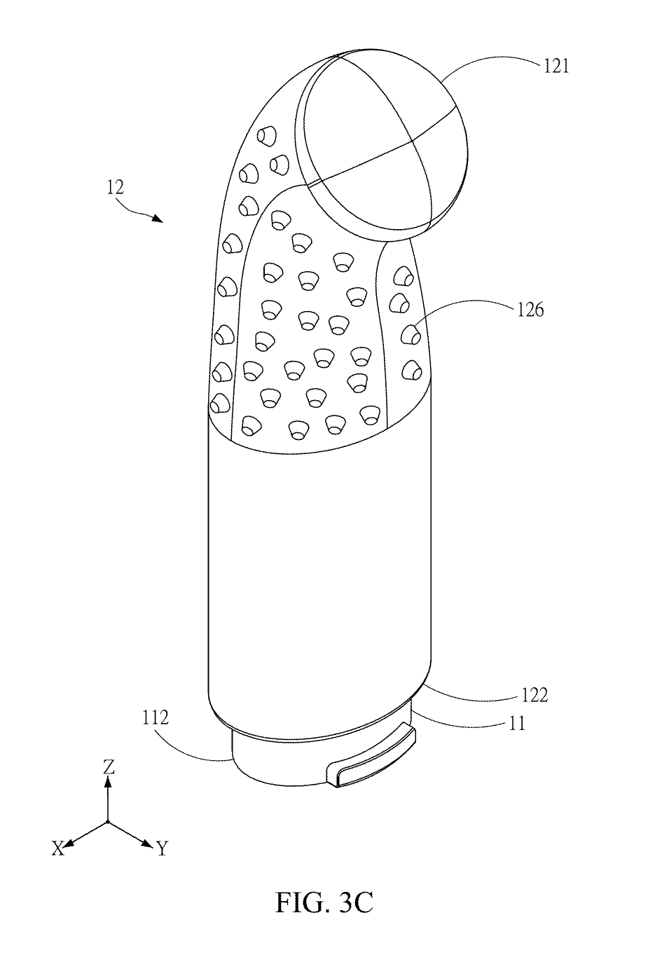

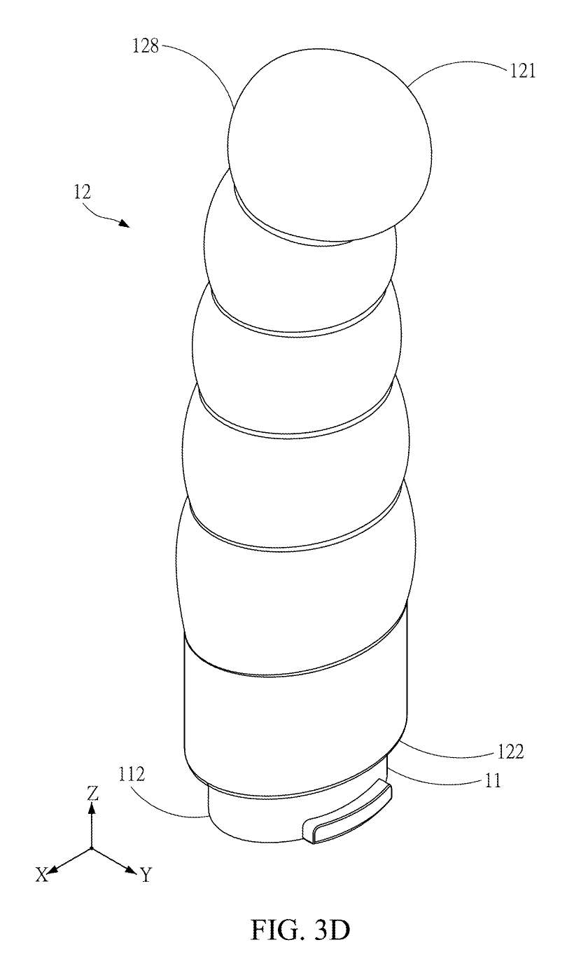

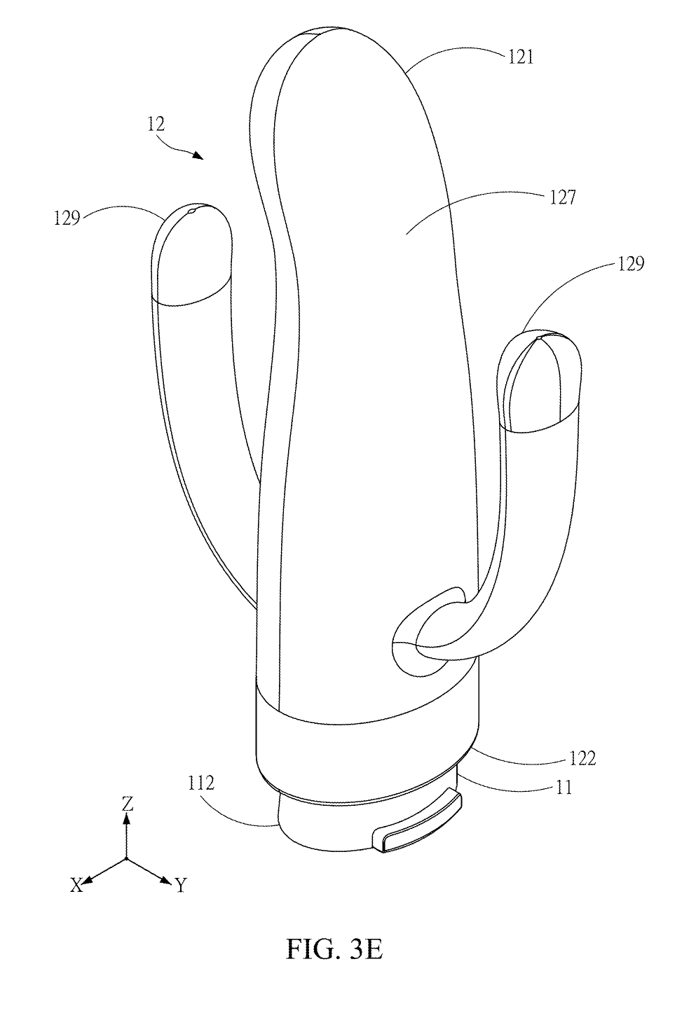

FIG. 3A is a perspective view (2) of the vibrating device of the first embodiment of the present invention. As shown in FIG. 3A, the first shaping portion 121 is a ball member 124. In other words, one end of the first rod portion 123 is connected to the first shaping portion 121 which is a ball shaped structure.

As shown in FIG. 3A, the first rod portion 123 is the bending segment, and the bending angle of the first rod portion 123 is the same as the first included angle θ₁.

FIG. 3B is a perspective view (3) of the vibrating device of the first embodiment of the present invention. As shown in FIG. 3B, the first shaping portion 121 is a helix structure 125. The helix structure 125 is a structure with annularly protruding helix features. Here, the protruding extent of each ring on the helix structure 125 can be the same or can be different; similarly, the width between each two rings on the helix structure 125 can be the same or can be different.

FIG. 3C is a perspective view (4) of the vibrating device of the first embodiment of the present invention. As shown in FIG. 3C, the first shaping portion 121 is a granular structure 126 having a plurality of protruded spots. Here, the protruding extent of each spot on the granular structure 126 can be the same or can be different; similarly, the size of each spot can be the same or can be different. In an implementation aspect, the granular structure 126 has protruded round features, protruded cone features, or protruded features with rose, animal, heart and star shapes, but embodiments of the present invention are not limited thereto.

In one embodiment, the protruded spots can be replaced by bristles; namely, the first shaping portion 121 is a bristled structure having a plurality of bristles. The bristles are made of natural hair fibers, artificial fibers, striped soft polymeric materials and so forth.

FIG. 3D is a perspective view (5) of the vibrating device of the first embodiment of the present invention. As shown in FIG. 3D, the first shaping portion 121 is a sectioned structure 128 having a plurality of protruded sections. The protruded sections are aligned along the major axis of the first extending member 12. Here, the protruded extent of each protruded section can be the same or can be different; the size of each protruded section can be the same or can be different. In an implementation aspect, the sectioned structure 128 has protruded round features, protruded cone features, or protruded features with texts, flower, animal, heart and star shapes, but embodiments of the present invention are not limited thereto.

FIG. 3E is a perspective view (6) of the vibrating device of the first embodiment of the present invention. As shown in FIG. 3E, the first extending member 12 includes a root unit 127 and at least one branch unit 129. Here, two branch units 129 are disposed at two sides of the root unit 127 respectively. The root unit 127 has the first shaping portion 121 and the first connecting portion 122. The branch units 129 are connected to the root unit 127 and are disposed between the first shaping portion 121 and the first connecting portion 122 (namely, the branch units 129 are disposed on the first rod portion 123). The branch units 129 are extended toward the first shaping portion 121. Here, the end-face of each branch unit 129 is an arc curved surface. In some embodiments, the branch unit 129 is capable of having the bending segment, the bail member 124, the helix structure 125, the granular structure 126, the bristled structure or the sectioned structure 128.

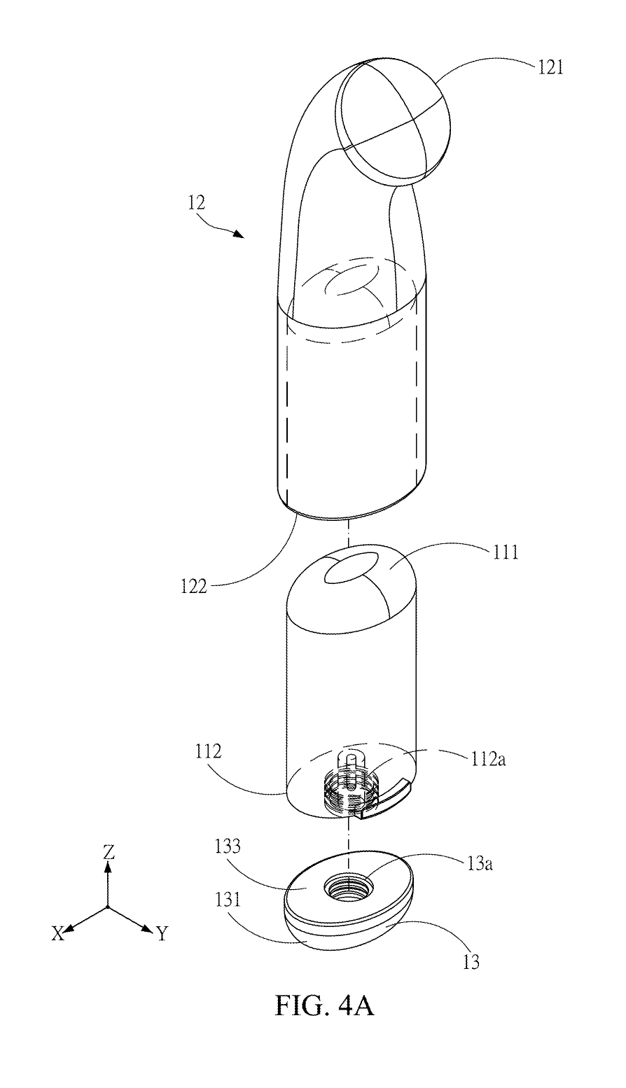

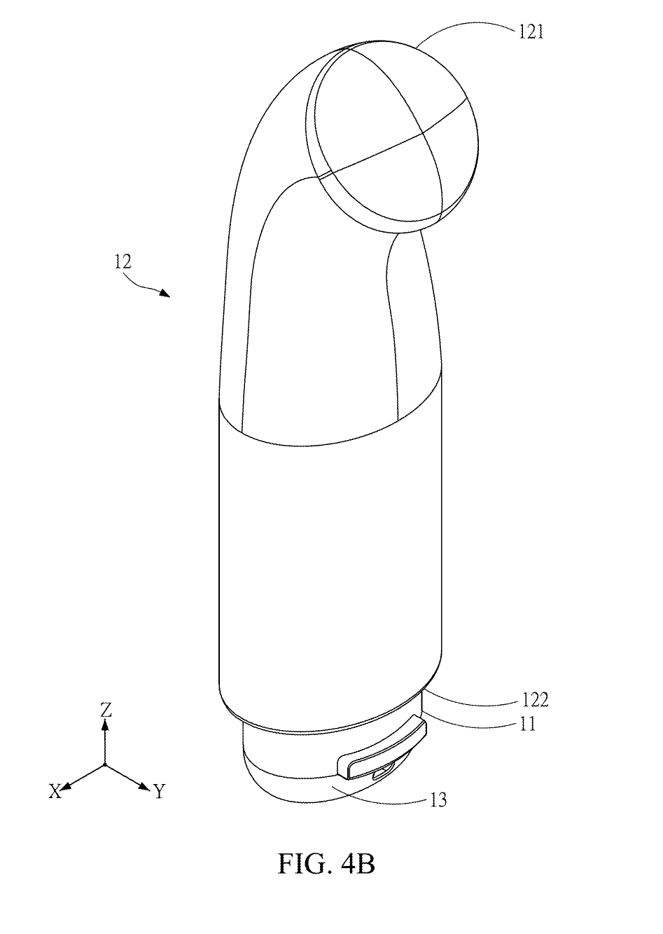

FIG. 4A is an exploded view (1) of a vibrating device of a second embodiment of the present invention. FIG. 4B is a perspective view (1) of the vibrating device of the second embodiment of the present invention. As shown in FIG. 4A, the vibrating device of the second embodiment is approximately the same as that of the first embodiment, except that the vibrating device of the second embodiment of the present invention further has a second extending member 13.

As shown in FIG. 4A, the second extending member 13 includes a second shaping portion 131 and a second connecting portion 133 in which the second shaping portion 131 is disposed opposite to the second connecting portion 133. The base body 11 has a first end 111 sleeved in the receiving groove 122a and a second end 112 opposite to the first end 111. The second connecting portion 133 is detachably connected to the second end 112 of the base body 11. One end-face of the base body 11 and the other end-face of the second connecting portion 133 have the same size and the same shape, in which one end-face of the base body 11 and the other end-face of the second connecting portion 133 contacts with each other. Based on this, when the second extending member 13 is connected to the base body 11, the second extending member 13 and the base body 11 are formed a smooth surface, as shown in FIG. 4B. Here, the second extending member 13 and the shell of the base body 11 are made of the same material, such as metal, so that the second extending member 13 and the base body 11 are in consistency with each other.

As shown in FIG. 4A, the second end 112 of the base body 11 has a threaded rod 112a, and the second extending member 13 has a threaded groove 13a corresponding to the threaded rod 112a. The threaded groove 13a is detachably combined with the threaded rod 112a so as to fasten the second extending member 13 with the second end 112 of the base body 11. But embodiments of the present invention are not limited thereto; in some embodiments, the base body 11 is connected to the second extending member 13 via threading, locking, engaging, magnetically attracting and so forth.

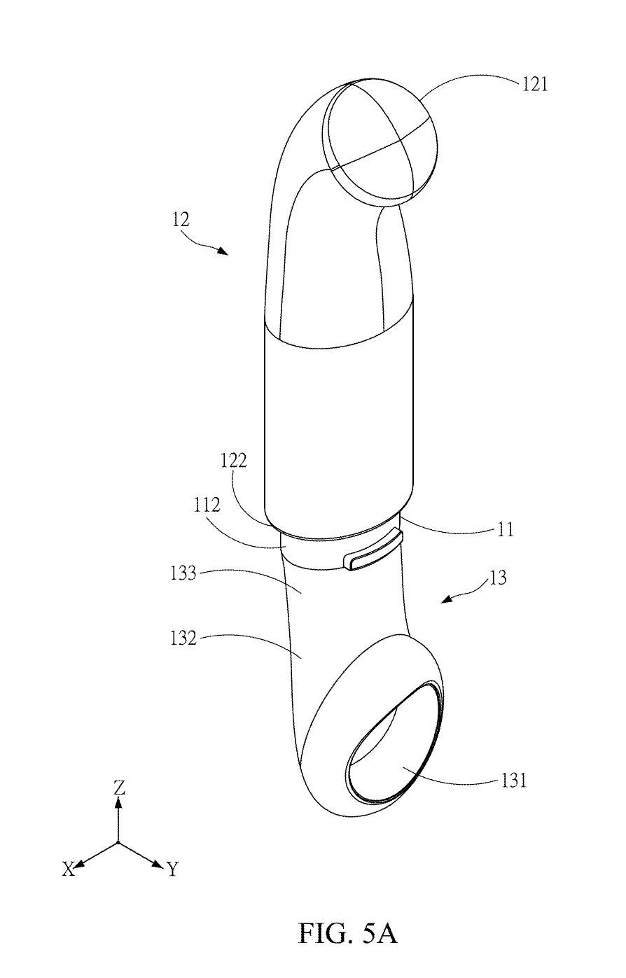

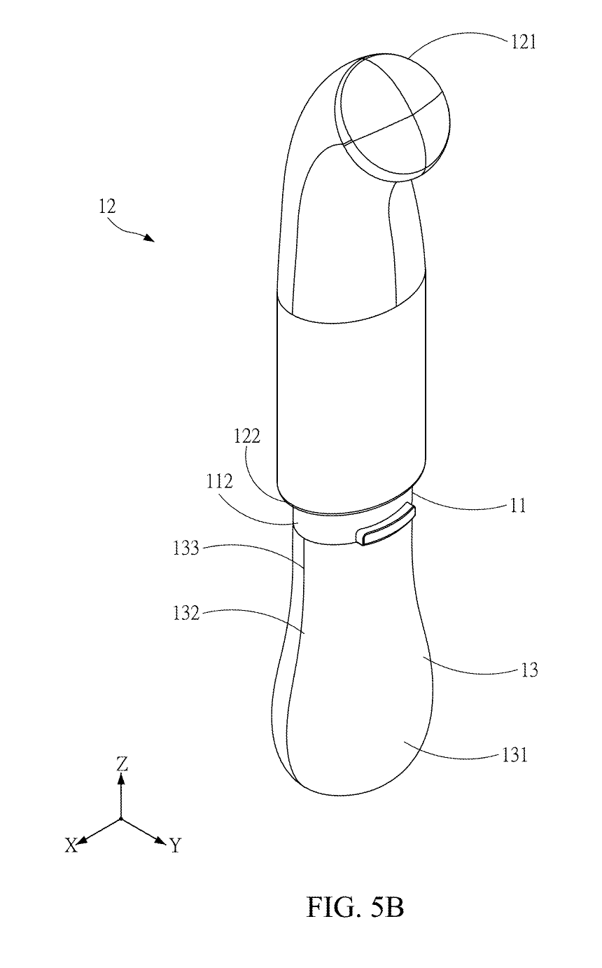

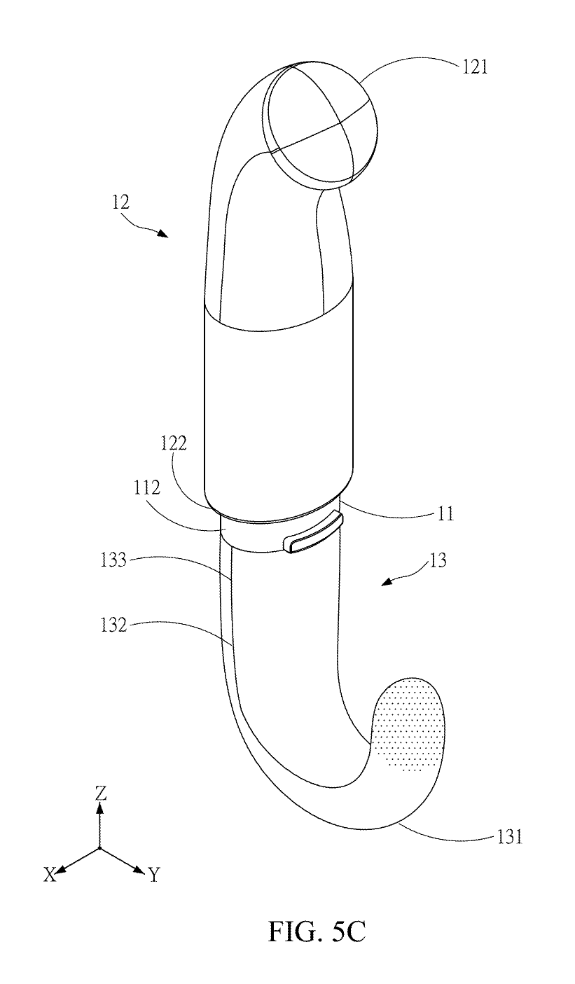

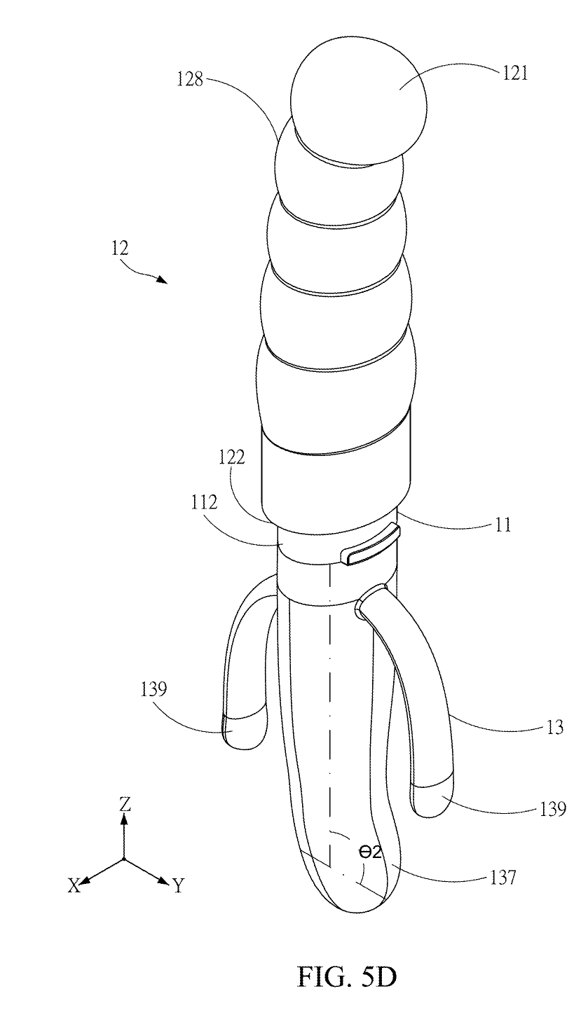

FIG. 5A is a perspective view (2) of the vibrating device of the second embodiment of the present invention. As shown in FIG. 5A, the second extending member 13 is approximately formed as stick shaped for holding. Here, the second shaping portion 131 of the second extending member 13 has a through hole, so that the vibrating device of the present invention is hanged for storing conveniently.

FIG. 5B is a perspective view (3) of the vibrating device of the second embodiment of the present invention. As shown in FIG. 5B, the size of the second shaping portion 131 of the second extending member 13 is larger than that of the second connecting portion 133. The second shaping portion 131 of the second extending member 13 is formed as handle shaped or cylindrical lock shaped, so that the user holds the vibrating device ergonomically.

Here, the second extending member 13 shown in FIG. 5A and FIG. 5B and the shell of the base body 11 are made of the same material, such as metal, so that the second extending member 13 and the base body 11 are in consistency with each other,

FIG. 5C is a perspective view (4) of the vibrating device of the second embodiment of the present invention. As shown in FIG. 5C, the second shaping portion 131 of the second extending member 13 is a bending segment bent toward the base body 11 so as to form hook shaped (namely, a J profile). Here, the second extending member 13 is made of elastic polymeric materials, such as silica gel or latex, but embodiments of the present invention are not limited thereto.

FIG. 5D is a perspective view (5) of the vibrating device of the second embodiment of the present invention. As shown in FIG. 5D, the structure of the second extending member 13 is similar to that of the first extending member 12 as mentioned above. The second extending member 13 includes a root unit 137 and at least one breach unit 139. Here, the end-face of each branch unit 139 is an arc curved surface.

In some embodiments, the root unit 137 and/or the branch units 139 includes the bending segment with a second included angle θ₂, the ball member 124, the helix structure 125, the granular structure 126, the bristled structure or the sectioned structure 128. That is to say, the second shaping portion 131 has the bending segment, the ball member 124, the helix structure 125, the granular structure 126, the bristled structure or the sectioned structure 128. Here, because the first end 111 and the second end 112 of the base body 11 are respectively connected to the first extending member 12 and the second extending member 13, the user can make the body thereof alternatively contacts with the first extending member 12 or the second extending member 13. Especially, when the first extending member 12 and the second extending member 13 have different shapes, the user can alternate the extending members with different shapes conveniently so as to acquire different feelings and comforts.

In an implementation aspect, the second included angle θ₂ is defined in a range between 90 and 180 degrees; preferably, the second included angle θ₂ is defined in a range between 100 and 150 degrees; the second included angle θ₂ is 135 degrees, for example.

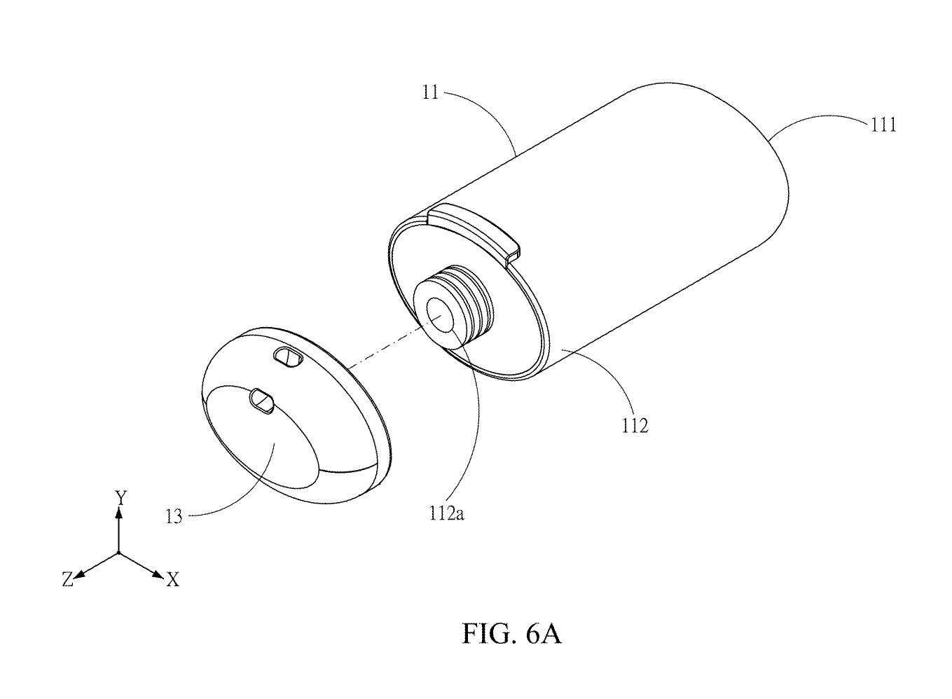

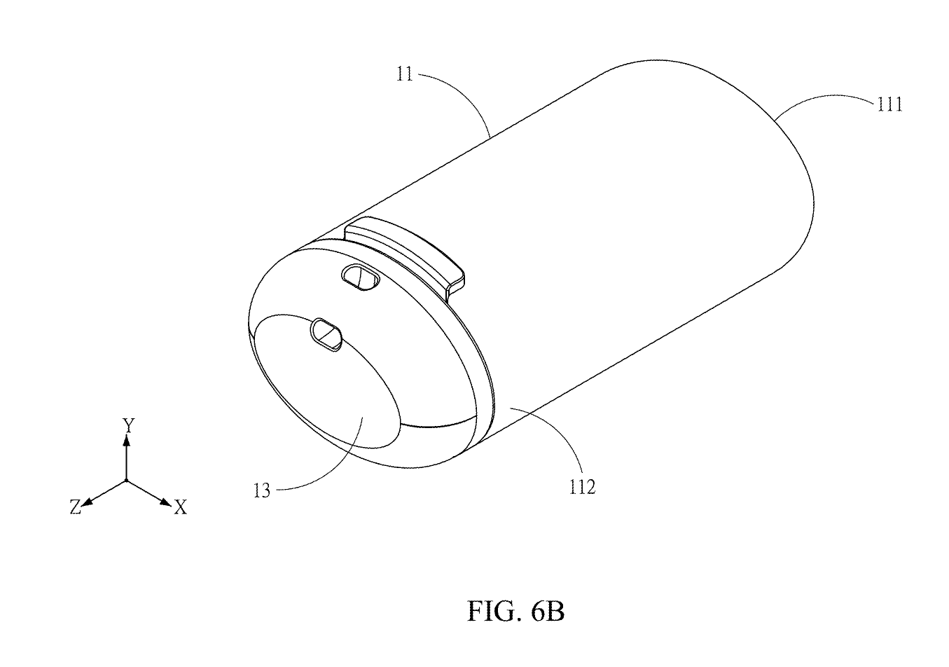

FIG. 6A is an exploded view (1) of a vibrating device of a third embodiment of the present invention. FIG. 6B is a perspective view (1) of the vibrating device of the third embodiment of the present invention. As shown in FIGS. 6A-6B, the vibrating device of the third embodiment is approximately the same as that of the first embodiment and the second embodiment, except that the vibrating device of the third embodiment of the present invention includes the base body 11 and the second extending member 13. That is to say, the vibrating device of the first embodiment of the present invention includes the base body 11 and the first extending member 12; the vibrating device of the second embodiment of the present invention includes the base body 11, the first extending member 12 and the second extending member 13; the vibrating device of the third embodiment of the present invention includes the base body 11 and the second extending member 13.

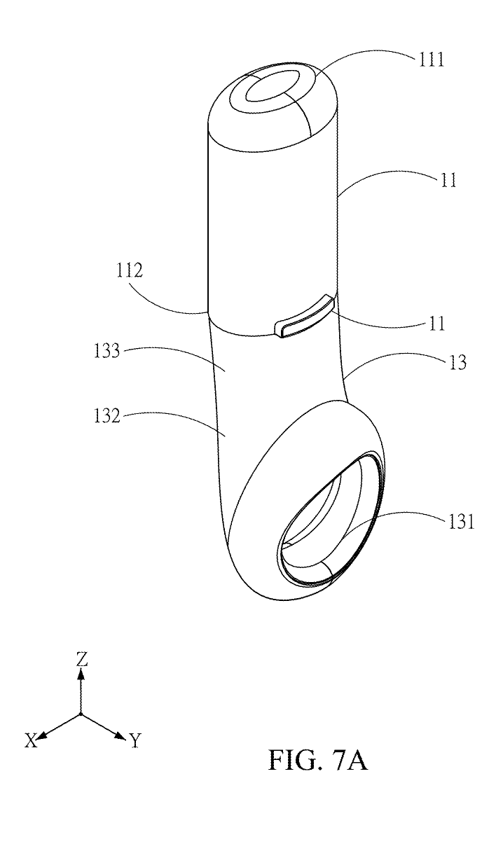

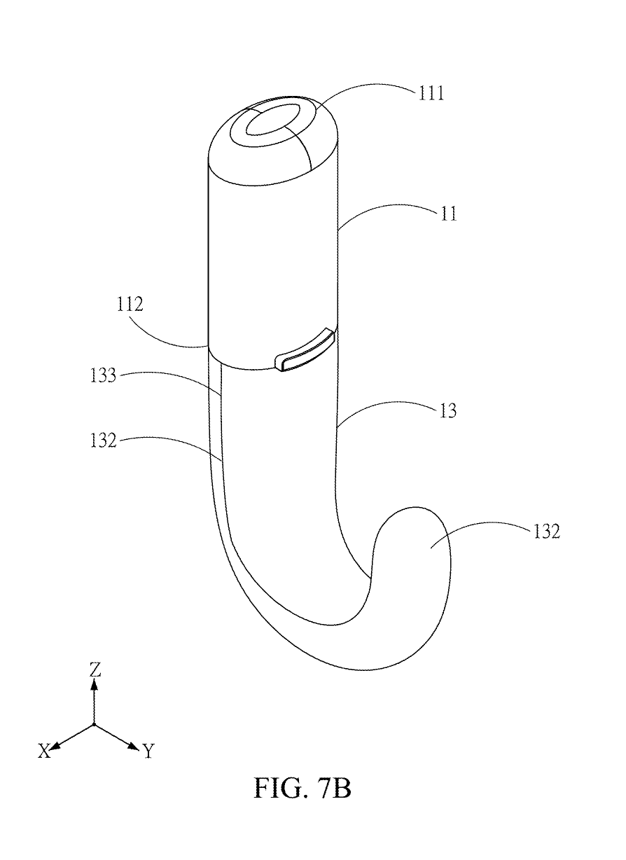

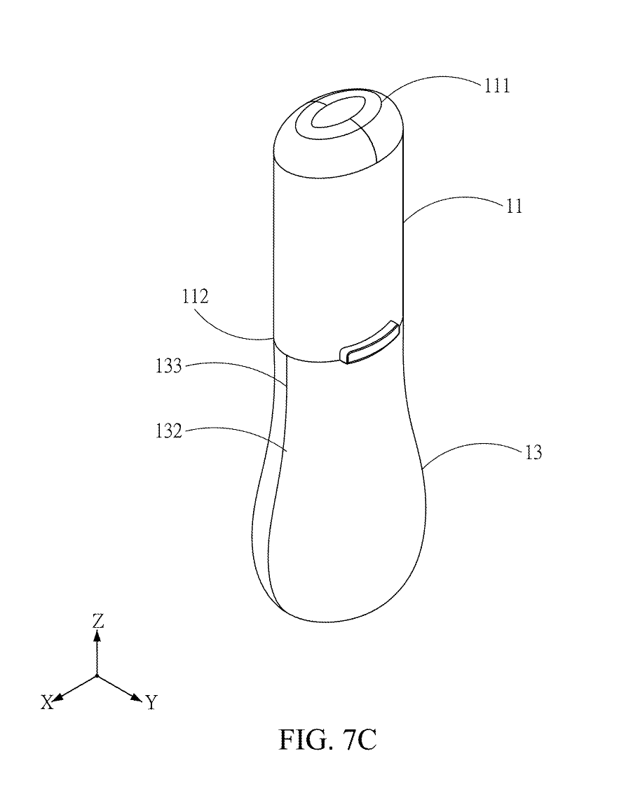

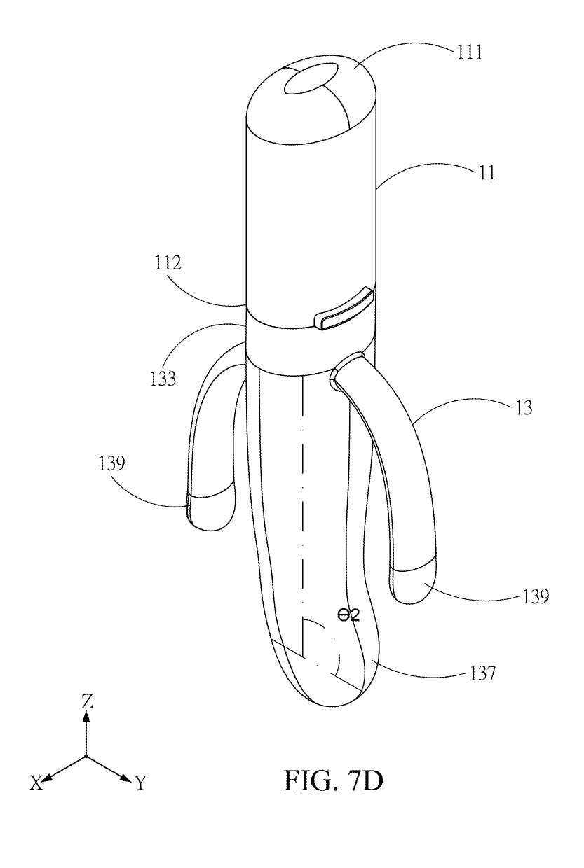

FIG. 7A is a perspective view (2) of the vibrating device of the third embodiment of the present invention. FIG. 7B is a perspective view (3) of the vibrating device of the third embodiment of the present invention. FIG. 7C is a perspective view (4) of the vibrating device of the third embodiment of the present invention. FIG. 7D is a perspective view (5) of the vibrating device of the third embodiment of the present invention.

Please refer to FIGS. 7A-7D, which show that the second shaping portion 131 of the second extending member 13 has the bending segment, the cylindrical lock shaped structure, the ball member 124, the helix structure 125, the granular structure 126, the bristled structure or the sectioned structure 128 as mentioned above. Alternatively, the second shaping portion 131 includes the root unit 137 and branch units 139, or includes the through hole as mentioned above.

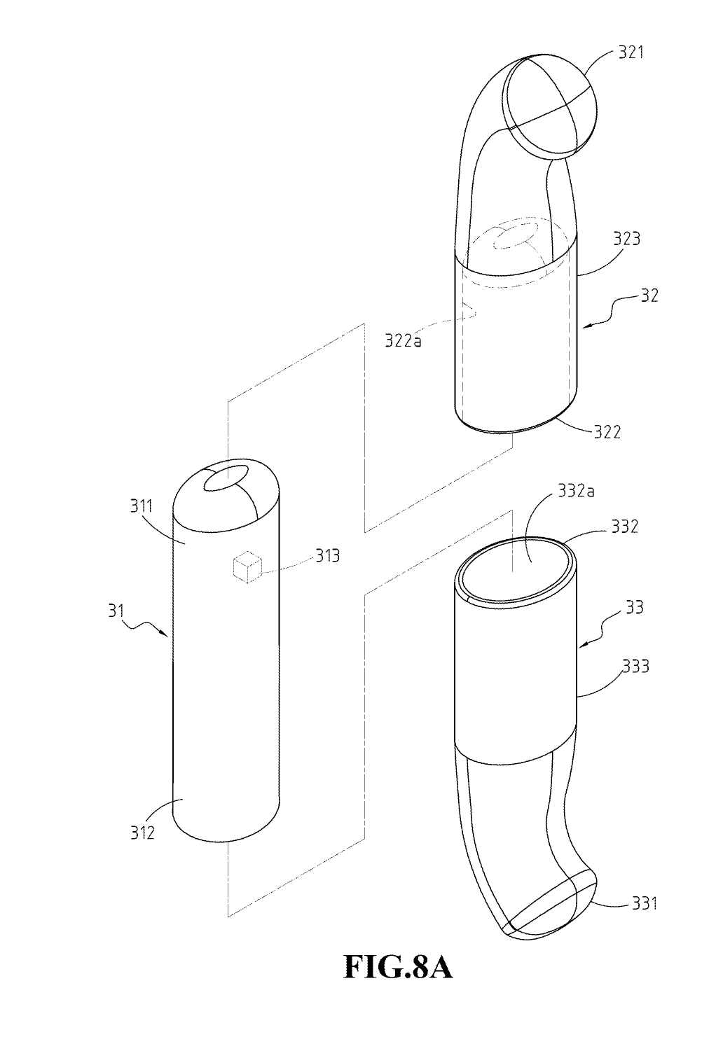

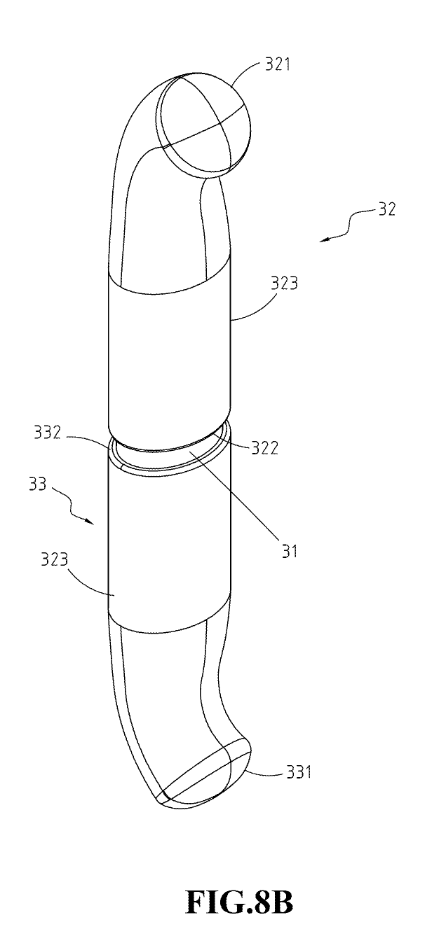

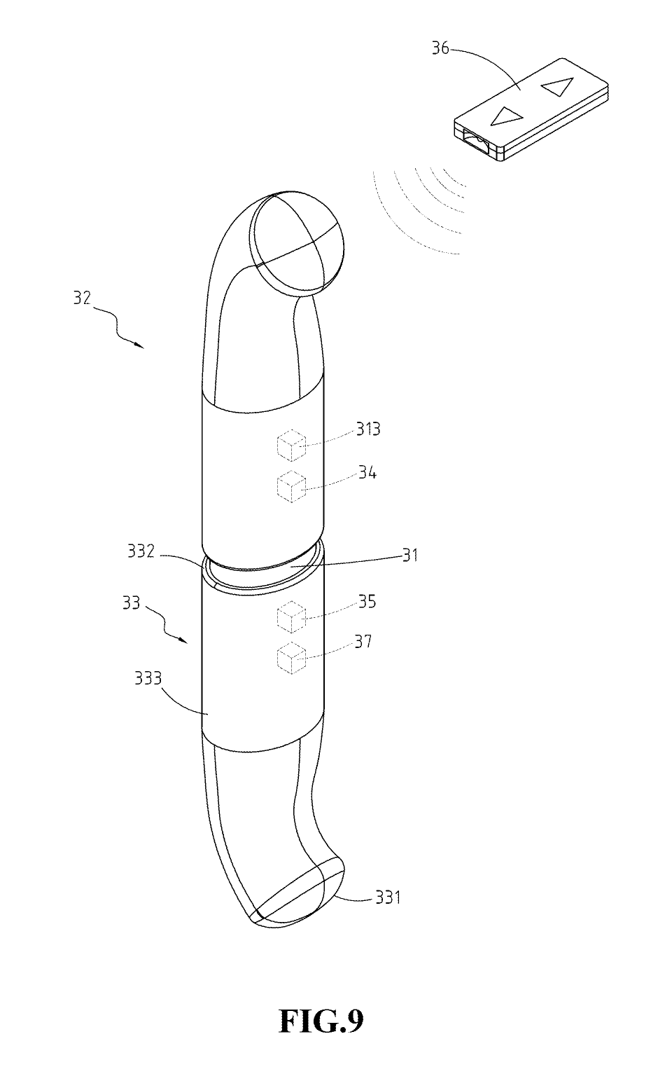

FIG. 8A is an exploded view of a vibrating device of a fourth embodiment of the present invention. FIG. 8B is a perspective view (1) of the vibrating device of the fourth embodiment of the present invention. FIG. 9 is an operating schematic view of the vibrating device of the fourth embodiment of the present invention.

Please refer to FIG. 8A, FIG. 8B and FIG. 9, a vibrating device of a fourth embodiment of the present invention includes a base body 31, a first extending member 32 and a second extending member 33. The base body 31 includes a first sleeving end 311 and a second sleeving end 312 opposite to the first sleeving end 311. For example, the angle defined between the extending direction of the first sleeving end 311 and the extending direction of the second sleeving end 312 can be 180 degrees, but embodiments of the present invention are not limited thereto. In other words, the design of the angle mentioned above can be altered according to user's requirements. The base body 31 is approximately formed as elongated shaped and has a vibrating motor 313 assembled therein (as shown in FIG. 8A).

As shown in FIG. 8A, the first extending member 32 is approximately formed as elongated shape; for example, the first extending member 32 can be a rod shaped structure, an elliptic-cylinder shaped structure or an egg shaped structure, but embodiments of the present invention are not limited thereto. The first extending member 32 includes a first shaping portion 321, a first connecting portion 322 and a first rod portion 323. Two ends of the first rod portion 323 are respectively connected to the first shaping portion 321 and the first connecting portion 322; for example; in this embodiment, the first shaping portion 321 and the first connecting portion 322 are respectively disposed at two ends of the major axis of the first extending member 32. The first connecting portion 322 has a first receiving groove 322a which is formed by recessing the first connecting portion 322 in a direction toward the first shaping portion 321. That is, the opening direction of the first receiving groove 322a is far from the first shaping portion 321. As shown in FIG. 8B, the first extending member 32 is sleeved onto one end of the base body 31, namely, the first sleeving end 311, via the first receiving groove 322a, such that the first sleeving end 311 of the base body 31 is enclosed by the first extending member 32, thereby completely delivering the vibration energy come from the first sleeving end 311 to the first extending member 32.

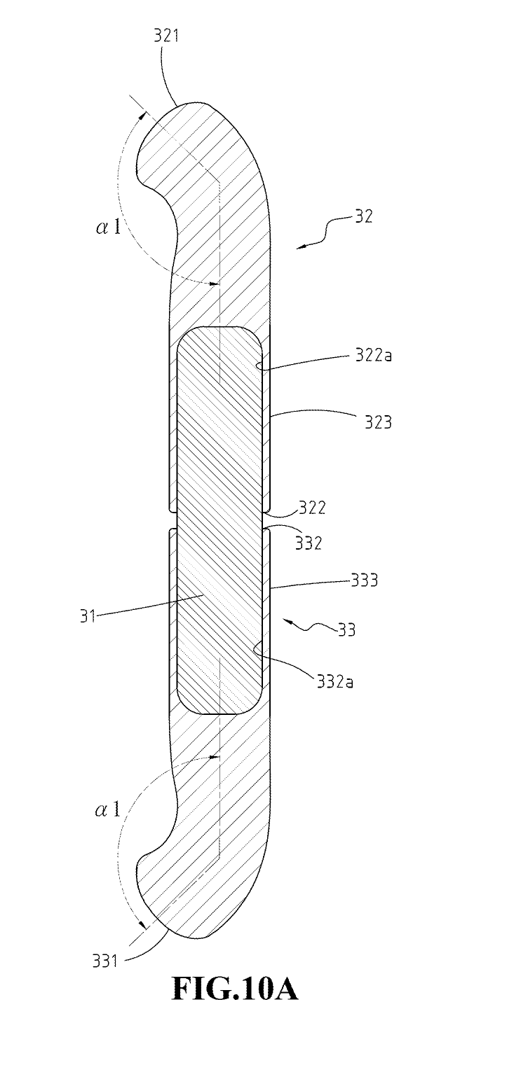

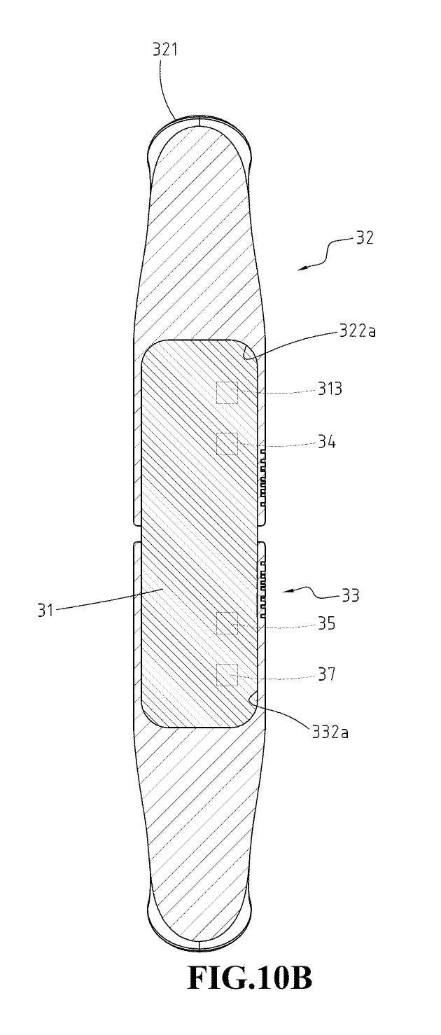

Please refer to FIG. 10A and FIG. 10B, which are a cross-sectional view (1) and a cross-sectional view of the vibrating device of the fourth embodiment of the present invention. The range of the depth of the first receiving groove 322a is approximately defined between 45 mm to 50 mm, for example, the depth of the first receiving groove 322a can be 45.5 mm. The range of the wall thickness of the first receiving groove 322a is approximately defined between 1 mm to 3 mm, for example, the wall thickness of the first receiving groove 322a can be 2 mm. The range of the inner width of the first receiving groove 322a is approximately defined between 28 mm to 32 mm, for example, the inner width of the first receiving groove 322a can be 29.95 mm. Based on this, the vibration generated from the vibrating motor 313 is delivered through the outer surface of the base body 31 to the first extending member 32; as a result, the first extending member 32 is vibrated along with the vibration of the vibrating motor 313.

Similarly, as shown in FIG. 8A, the second extending member 33 is approximately formed as elongated shaped; for example, the second extending member 33 can be a rod shaped structure, an elliptic-cylinder shaped structure or an egg shaped structure, but embodiments of the present invention are not limited thereto. The second extending member 33 includes a second shaping portion 331, a second connecting portion 332 and a second rod portion 333. Two ends of the second rod portion 333 are respectively connected to the second shaping portion 331 and the second connecting portion 332; for example, in this embodiment, the second shaping portion 331 and the second connecting portion 332 are respectively disposed at two ends of the major axis of the second extending member 33. The second connecting portion 332 has a second receiving groove 332a formed by recessing the second connecting portion 332 in a direction toward the second shaping portion 331. That is, the opening direction of the second receiving groove 332a is far from the second shaping portion 331. As shown in FIG. 8B, the second extending member 33 is sleeved onto the other end of the base body 31, namely, the second sleeving end 312, via the second receiving groove 332a, such that the second sleeving end 312 of the base body 31 is enclosed by the second extending member 33, thereby completely delivering the vibration energy come from the second sleeving end 312 to the second extending member 33.

In this embodiment, when the first extending member 32 is sleeved onto the first sleeving end 311 of the base body 31 via the first receiving groove 322a and the second extending member 33 is sleeved onto the second sleeving end 312 of the base body 31 via the second receiving groove 332a, the groove opening of the first receiving groove 322a and the groove opening of the second receiving groove 332a are opposite to each other, so that the size of the whole vibrating device is increased; but embodiments of the present invention are not limited thereto. In some embodiments, an included angle is defined between the groove opening of the first receiving groove 322a and the groove opening of the second receiving groove 332a.

Please refer to FIG. 10A again, the range of the depth of the second receiving groove 332a is approximately defined between 45 mm to 50 mm, for example, the depth of the second receiving groove 332a can be 45.5 mm. The range of the wall thickness of the second receiving groove 332a is approximately defined between 1 mm to 3 mm, for example, the wall thickness of the second receiving groove 332a can be 2 mm. The range of the inner width of the second receiving groove 332a is approximately defined between 28 mm to 32 mm, for example, the inner width of the second receiving groove 332a can be 29.95 mm. Based on this, the vibration generated from the vibrating motor 313 is delivered through the outer surface of the base body 31 to the second extending member 33; as a result, the second extending member 33 is vibrated along with the vibration of the vibrating motor 313.

In one embodiment, the base body 31 is formed as cuboid or an elliptical cylinder, and the edges and the corners thereof are chamfered to be smooth, but embodiments of the present invention are not limited thereto. As shown in FIG. 8A, one end of the first shaping portion 321 or one end of the second shaping portion 331 is an arc curved surface.

The base body 31 includes a shell which is made of metals, tempered glass, or other rigid materials, and the vibrating motor 313 is assembled in the shell. One of the first extending member 32 and the second extending member 33 is made of elastic polymeric materials, such as silica gel or latex, but embodiments of the present invention are not limited thereto.

As shown in FIG. 8A and FIG. 8B, since the first extending member 32 and the second extending member 33 are both made of elastic materials, the groove openings of the first receiving groove 322a and the second receiving groove 332a can be expanded by the base body 31, so that the first extending member 32 and the second extending member 33 can be respectively sleeved onto the first sleeving end 311 and the second sleeving end 312 of the base body 31. In addition, the total receiving volume of the first receiving groove 322a and the second receiving groove 332a is smaller to or equal to the volume of the base body 31, such that the first receiving groove 322a and the second receiving groove 332a are both closely combined with the base body 31. Based on this, the user can hold the first extending member 32 for body massaging using the second extending member 33; or, the user can hold the second extending member 33 for body massaging using the first extending member 32; furthermore, the first extending member 32 and the second extending member 33 can be simultaneously applied for one or more than one users for body massaging.

Besides, because of the material selection of the first extending member 32 and the second extending member 33, and the design of the wall thickness and the depth of the first receiving groove 322a and the second receiving groove 332a, the first extending member 32 and the second extending member 33 can be closely sleeved onto the base body 31, such that the vibration generated from the vibrating motor 313 in the base body 31 can be delivered to the first extending member 32 and the second extending member 33 with high efficiency; therefore, not only the consumption of electricity of the vibrating device can be reduced, but the massaging performance of the vibrating device can be increased.

Please refer to FIG. 10A, in one embodiment, one of the first shaping portion 321 and the second shaping portion 331 is a bending segment, and the bending angle of the bending segment is a first angle α1, so that the outline of the first shaping portion 321 is ergonomic. The first angle al is defined in a range between 90 degrees and 180 degrees; preferably, the first angle al is defined in a range between 100 and 150 degrees; for example, the first angle α1 is 135 degrees.

As shown in FIG. 9, the vibrating device further includes a power supply 34, a control module 35 and a heating module 37. The power supply 34, the control module 35 and the heating module 37 are assembled in the base body 31 and are electrically connected with each other. Further, the power supply 34 and the control module 35 are capable of electrically connected with the vibrating motor 313. Here, the power supply 34 is a rechargeable battery (such as a nickel-metal hydride battery or a lithium battery) or a non-rechargeable battery (such as an alkaline battery), but embodiments of the present invention are not limited thereto.

In one embodiment, the vibrating device has a connecting port assembled thereon to receive an outer electrical source (such as supply mains, power device with a USB interface, etc).

As shown in FIG. 9, the control module 35 receives a control signal from an outer remote-control module 36, so that the vibrating frequency and the vibrating intensity of the vibrating motor 313 are adjusted according to the control signal. Here, the control module 35 substantially includes a micro control member and a first communication unit, and the remote-control module 36 includes a second communication unit. Both the first communication unit and the second communication unit can be substantially embodied via communication chips and communication circuits. The control signal can be transmitted via wire transmission (such as USB), or wireless transmission (such as infrared or Bluetooth).

The heating module 37 receives electricity from the power supply 34 and is heated via the controlling of the control module 35, so that the temperature of the shell of the base body 31 is increased. In some embodiments, the first extending member 32 or the second extending member 33 have a plurality of heat conducted portions extended longitudinally on the inner surface thereof. One ends of the heat conducted portions contact with the shell of the base body 31, so that the heat on the base body 31 is transmitted to the other ends of the heat conducted portions. Based on this, the first shaping portion 321 of the first extending member 32 or the second shaping portion 331 of the second extending member 33 receives the heat from the heat conducted portions and the temperature of the surface of the first extending member 32 or that of the second extending member 33 is increased to enhance the comfortableness during massaging.

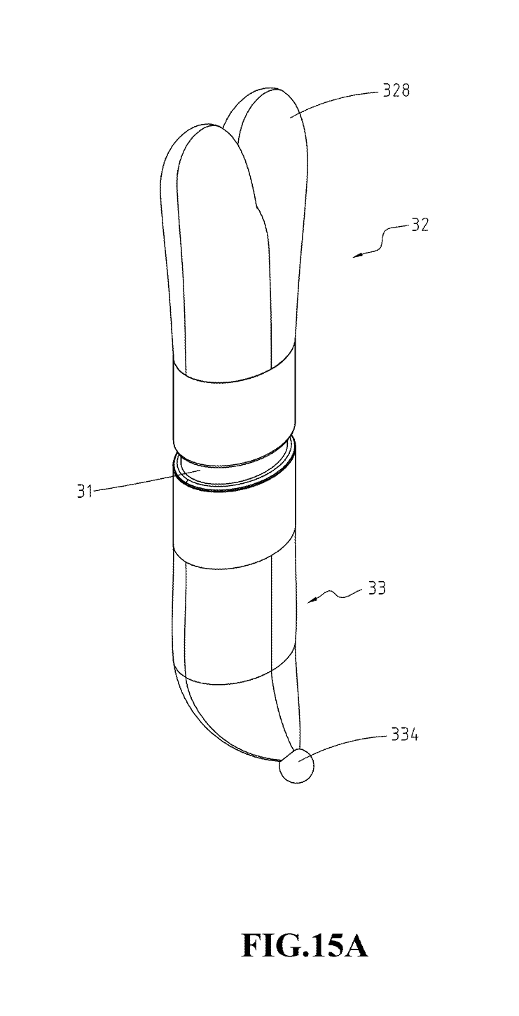

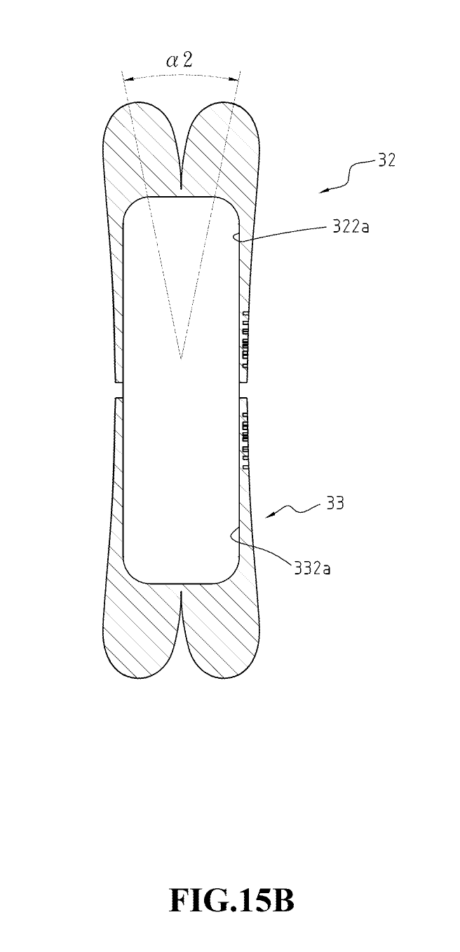

Please refer to FIG. 11 and FIG. 15A, which respectively are a perspective view (2) and a perspective view (6) of the vibrating device of the fourth embodiment of the present invention One of the first shaping portion 321 and the second shaping portion 331 can be a ball member 324 (334). In other words, taking the first extending member 32 as an example, one end of the first rod portion 323 is connected to the first shaping portion 321 in which the first shaping portion 321 is ball shaped.

As shown in FIG. 11, the first rod portion 323 or the second rod portion 333 can be the bending segment, and the bending angle of the first rod portion is the same as the first angle α1.

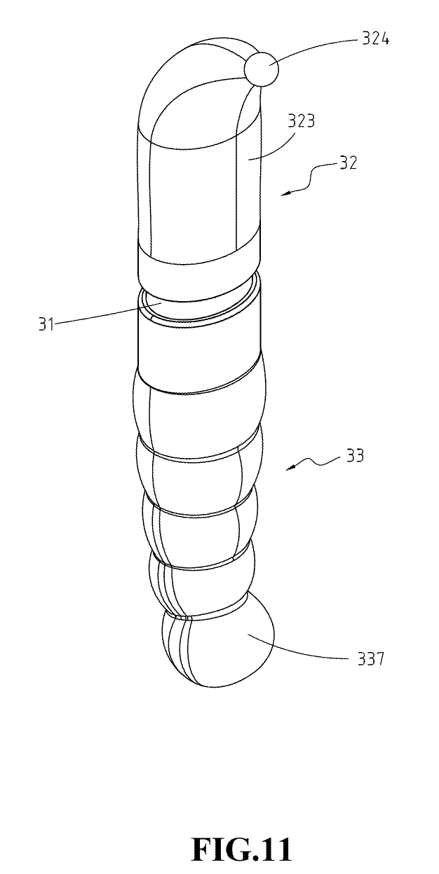

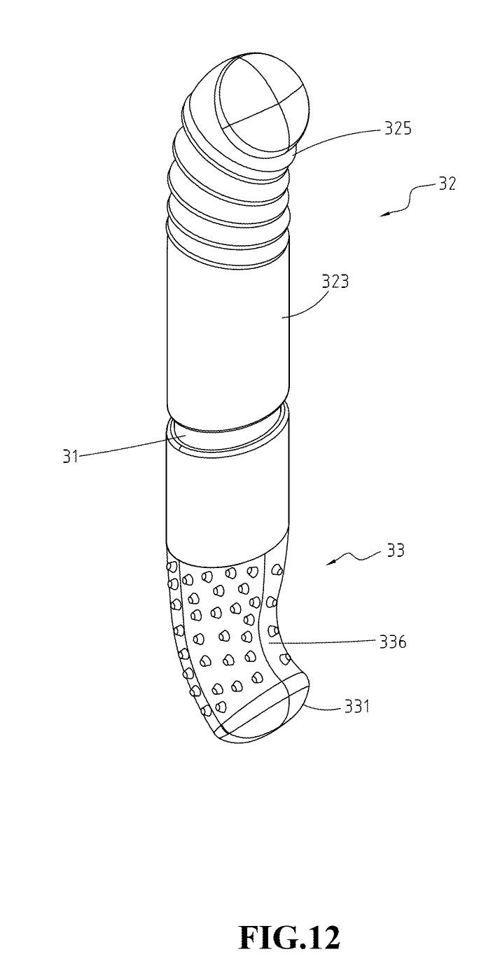

Please refer to FIG. 12 and FIG. 15A, which are a perspective view (3) and the perspective view (6) of the vibrating device of the fourth embodiment of the present invention. One of the shaping portion 321 and the second shaping portion 331 can be a helix structure 325 (335). The helix structure 325 (335) is a structure with annularly protruding helix features. Here, the protruding extent of each ring on the helix structure 325 (335) can be the same or can be different; similarly, the width between each two rings on the helix structure 325 (335) can be the same or can be different.

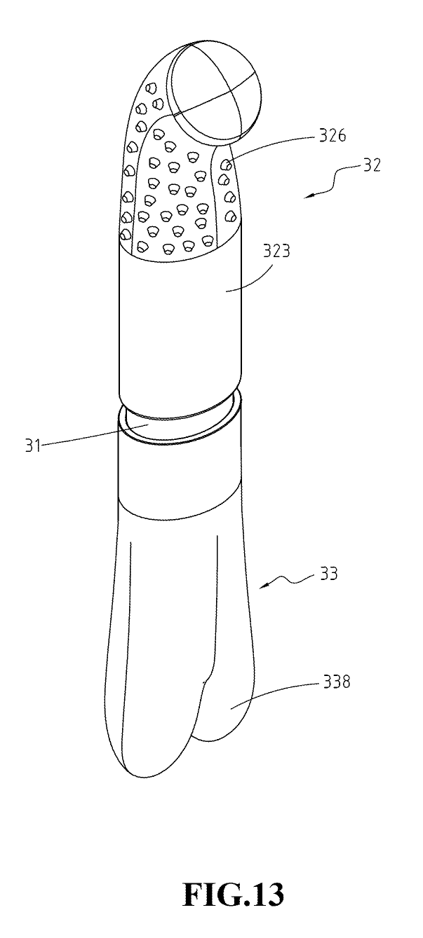

Please refer to FIG. 12 and FIG. 13, which are the perspective view (3) and a perspective view (4) of the vibrating device of the fourth embodiment of the present invention. One of the first shaping portion 321 and the second shaping portion 331 is a granular structure 326 (336) having a plurality of protruded spots. Here, the protruding extent of each spot on the granular structure 326 (336) can be the same or can be different; similarly, the size of each spot can be the same or can be different. In an implementation aspect, the granular structure 326 (336) has protruded round features, protruded cone features, or protruded features with rose, animal, hearts and star shapes, but embodiments of the present invention are not limited thereto.

In one embodiment, the protruded spots can be replaced by bristles; namely, one of the first shaping portion 321 and the second shaping portion 331 is a bristled structure having a plurality of bristles. The bristles are made of natural hair fibers, artificial fibers, striped soft polymeric materials and so forth.

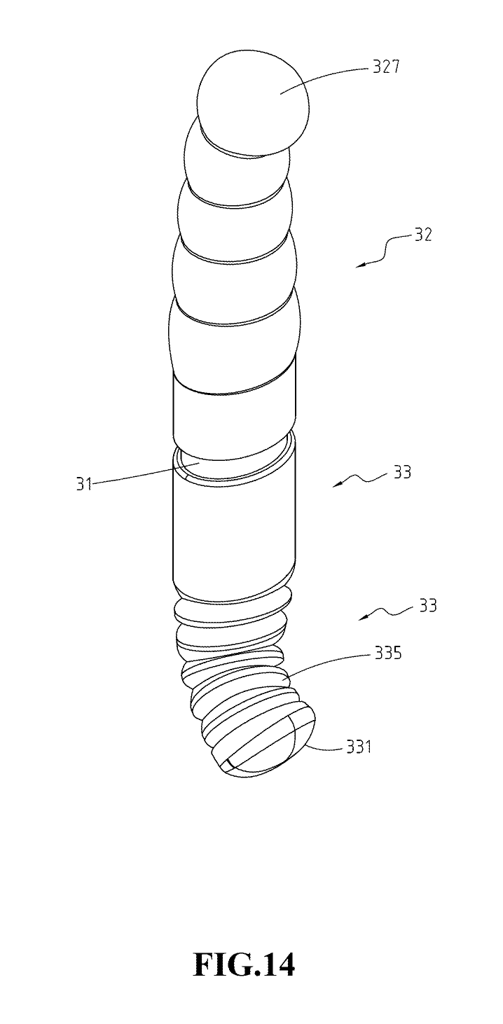

Please refer to FIG. 11 and FIG. 14, which are the perspective view (2) and a perspective view (5) of the vibrating device of the fourth embodiment of the present invention. One of the first shaping portion 321 and the second shaping portion 331 is a sectioned structure 327 (337) having a plurality of protruded sections. The protruded sections are aligned along the major axis of the first extending member 32 (or the second extending member 33). Here, the protruded extent of each protruded section can be the same or can be different; the size of each protruded section can be the same or can be different. In one implementation aspect, the sectioned structure 327 (337) has protruded round features, protruded cone features, or protruded features with texts, flower, animal, heart and star shapes, but embodiments of the present invention are not limited thereto.

Please refer to FIG. 13, FIG. 15A and FIG. 15B, which are a perspective view (4) of the vibrating device, the perspective view (6) and a cross-sectional view (3) of the vibrating device of the fourth embodiment of the present invention, respectively. One of the two ends of the first shaping portion 321 and the second shaping portion 331 are two extruding portions 328 (338). Besides, as shown in FIG. 15B, a second angle α2 is defined between the two extruding portions 328 (338). With a lateral view, the outline of the first shaping portion 321 (or the second shaping portion 331) having the two extruding portions 328 (338) is formed as Y profiled. The second angle α2 is defined between 30 degrees and 75 degrees.

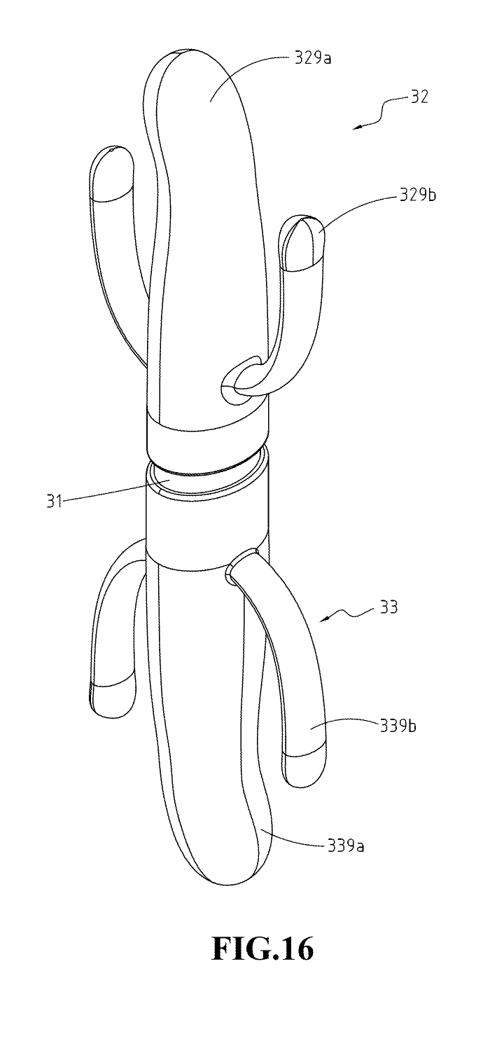

FIG. 16 is a perspective view (7) of the vibrating device of the fourth embodiment of the present invention. As shown in FIG. 16, the first extending member 32 includes a first root unit 329a and at least a first branch unit 329b. Here, two first branch units 329b are disposed at two sides of the first root unit 329a respectively. The first root unit 329a has the aforementioned first shaping portion 321 and the first connecting portion 322. The first branch units 329b are connected to the first root unit 329a and disposed between the first shaping portion 321 and the first connecting portion 322 (that is, the first branch units 329b are disposed on the first rod portion 323). The first branch units 329b are extended toward the first shaping portion 321. Here, the end-face of each first branch unit 329b is an arc curved surface. In some embodiments, the first branch unit 329b is capable of having the bending segment, the ball member 324, the helix structure 325, the granular structure 326, the bristled structure or the sectioned structure 327.

Please refer to FIG. 16 again, similar to the first extending member 32, the second extending member 33 is capable of including a second root unit 339a and at least a second branch unit 339b. Here, two second branch units 339b are disposed at two sides of the second root unit 339a respectively. The second root unit 339a has the aforementioned second shaping portion 331 and the second connecting portion 332. The second branch units 339b are connected to the second root unit 339a and disposed between the second shaping portion 331 and the second connecting portion 332 (that is, the second branch units 339b are disposed on the second rod portion 333). The second branch units 339b are extended toward the second shaping portion 331. Here, the end-face of each second branch unit 339b is an arc curved surface. In some embodiments, the second branch unit 339b is capable of having the bending segment, the ball member 334, the helix structure 335, the granular structure 336, the bristled structure or the sectioned structure 337.

In light of this, the features shown in one embodiment of the present invention can certainly be applied to another embodiment of the present invention.

In one embodiment, the outline of one of the first extending member 32 and the second extending member 33 is proper for holding (as shown in FIG. 10B), and the other extending member 32, 33 can be formed as the structure shown in FIGS. 11-16. Based on this, due to a great diversity of the outlines of the first extending member 32 and the second extending member 33, the user can hold one of the extending member 32, 33 which is proper for holding and do body massage with the other one of the extending member 32, 33 which is proper for massaging; besides, the first extending member 32 and the second extending member 33 can be simultaneously applied for one or more than one users for massaging.

In one embodiment, that is a fifth embodiment of the present invention, in order to make the first extending member 32 and/or the second extending member 32 be detached from the base body easily, the first receiving groove 322a of the first extending member 32 and/or the second receiving groove 332a of the second extending member 33 have a plurality of recessed grooves 20 opened thereon. Hereinafter, the second extending member 33 shown in FIG. 8A is taken as an exemplary example.

Please refer to FIG. 17, which is a perspective view of the vibrating device of the fifth embodiment of the present invention. The second extending member 33 has an inner surface 21 and an outer surface 22 opposite to the inner surface 21. The inner surface 21 (that is, the lateral surface of the second receiving groove 332a) has the recessed grooves 20 opened thereon. The recessed grooves 20 can be divided into a plurality of groups and are disposed at different regions of the inner surface 21 respectively. Here, the number of the group is two, the number of the recessed grooves 20 for each group is five, and the two groups are disposed opposite to each other. Besides, the outlines of the recessed grooves 20 of each group are linear and the channels of the recessed grooves 20 of each group are arranged parallel with each other; it is to be understood that the direction of the recessed grooves 20 can be designed according to user's requirements. In this embodiment, the recessed grooves 20 are opened toward a center direction; for example, the center direction can be toward the centre of the ellipsoid, but embodiments of the present invention are not limited thereto. Based on this, when the user applies pull force to detach the second extending member 33 from the base body 31, the overlapped area between the inner surface 21 of the second extending member 33 and the base body 31 is reduced because of the existence of the recessed grooves 20, such that the friction between the second extending member 33 and the base body 31 is reduced, thereby the detaching of the second extending member 33 from the base body 31 becoming much easier. The manufacturing method of the recessed grooves 20 can be altered according to user's requirements; for example, the recessed grooves 20 and the inner surface 21 the extending member 32, 33 can be integrally formed as a whole; alternatively, the extending member 32, 33 and the recessed grooves 20 can be manufactured separately, and the recessed grooves 20 are assembled on the inner surface 21 of the extending member 32, 33 later; or, the extending member 32, 33 can be manufactured firstly, then forming the recessed grooves 20 on the inner surface 21 of the extending member 32, 33 and so forth.

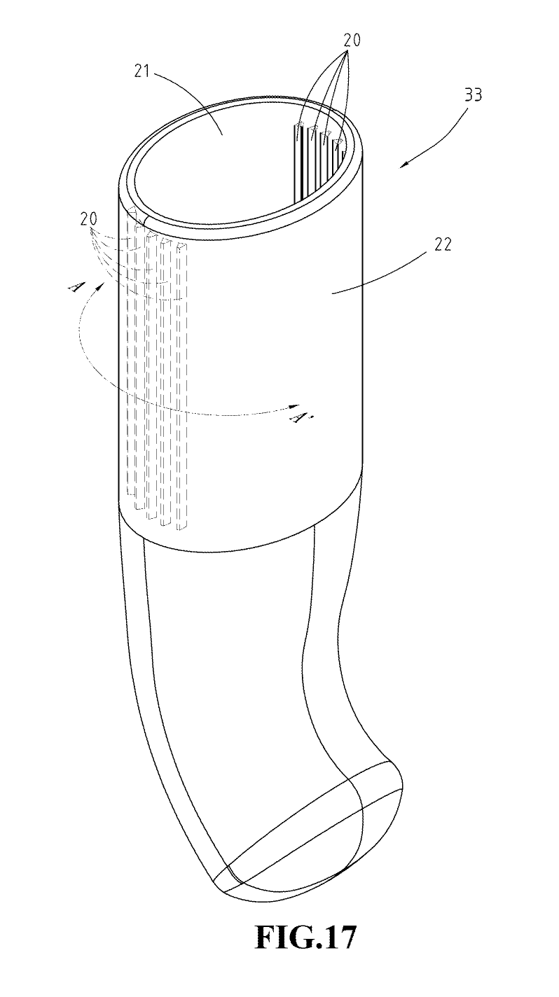

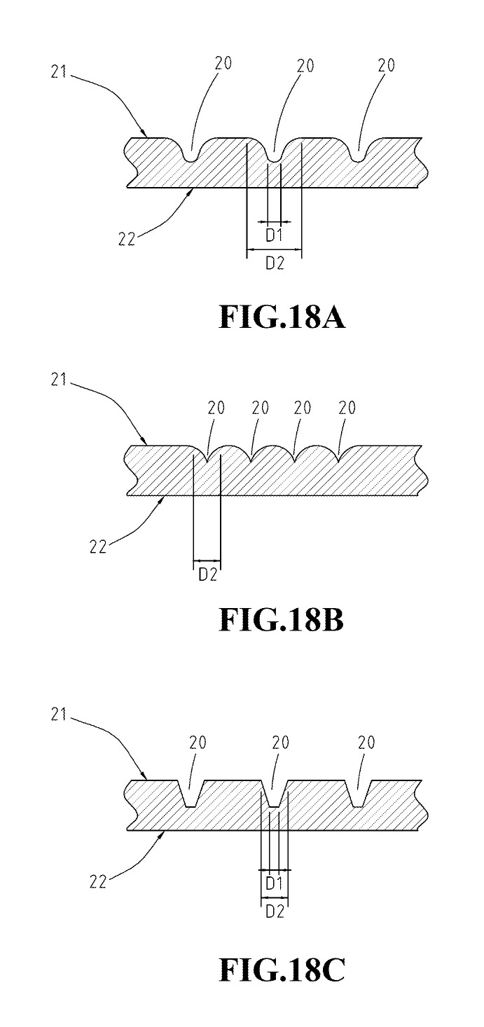

Please refer to FIG. 18A, which is an enlarged cross-sectional view (1) along line A-A′ shown in FIG. 17. The button width D1 of each recessed groove 20 is smaller than the opening width D2 of each recessed groove 20, thus the contact area between the inner surface 21 of the second extending member 33 and the base body 31 can be further reduced. Here, the flanges of the groove opening and the groove button of the recessed grooves 20 are both filleted.

Please refer to FIG. 18B, which is an enlarged cross-sectional view (2) along line A-A′ shown in FIG. 17. The difference between FIG. 18A and FIG. 18B is, the profile of the cross section between each two recessed grooves 20 of the inner surface 21 shown in FIG. 18B is rounded, and the profile of the cross section of each recessed groove 20 is approximately formed as V-shaped.

Please refer to FIG. 18C, which is an enlarged cross-sectional view (3) along line A-A′ shown in FIG. 17. The difference between FIG. 18A and FIG. 18C is, the flanges of the groove opening and the groove button of the recessed grooves 20 are neither filleted, namely, are both angular.

Based on the above, according to the user's requirement, the detachable first extending member 12 and/or the detachable second extending member 13 are selectively connected with the base body 11 of the vibrating device; or, alternatively, the first extending member 32 and/or the second extending member 33 can sleeved onto the base body 31 so as to provide different feelings for the user. Accordingly, the problem which cannot he solved by the conventional massage vibrator can be completely solved by the vibrating device with changeable extending members.

While the present invention has been described by the way of example and in terms of the preferred embodiments, it is to be understood that the invention need not be limited to the disclosed embodiments. On the contrary, it is intended to cover various modifications and similar arrangements included within the spirit and scope of the appended claims, the scope of which should be accorded the broadest interpretation so as to encompass all such modifications and similar structures.

What is claimed is:

1. A vibrating device, comprising:
a base body, having a vibrating motor assembled therein; and
a first extending member, approximately formed as elongated shape, comprising a first shaping portion and a first connecting portion, the first shaping portion and the first connecting portion respectively disposed at two ends of the major axis of the first extending member, the first connecting portion having a receiving groove formed by recessing the first connecting portion in a direction toward the first shaping portion, the receiving groove being sleeved onto one end of the base body,

2. The vibrating device according to claim 1, wherein the first shaping portion is selected from the group consisting of a bending segment, a ball member, a helix structure, a granular structure having a plurality of protruded spots, a bristled structure having a plurality of bristles and a sectioned structure having a plurality of protruded sections.

3. The vibrating device according to claim 1, wherein one end of the first shaping portion is an arc curved surface.

4. The vibrating device according to claim 1, wherein the first extending member further comprises:
a root unit, having the first shaping portion and the first connecting portion; and
at least one branch unit, connected to the root unit, disposed between the first shaping portion and the first connecting portion and extended toward the first shaping portion.

5. The vibrating device according to claim 1, wherein the first extending member is made of elastic polymeric materials.

6. The vibrating device according to claim 1, further comprising: a second extending member, comprising a second shaping portion and a second connecting portion, in which the second shaping portion is disposed opposite to the second connecting portion, the second connecting portion of the second extending member is detachably connected to the other end of the base body, one end-face of the base body and the other end-face of the second connecting portion have the same size and the same shape, in which one end-face of the base body and the other end face of the second connecting portion contacts with each other.

7. The vibrating device according to claim 6, wherein the base body is connected to the second extending member via a means selected from the group consisting of threading, locking, engaging and magnetically attracting.

8. The vibrating device according to claim 6, wherein the second shaping portion has a through hole.

9. The vibrating device according to claim 6, wherein the second extending member is selected from the group consisting of a bending segment, a ball member, a helix structure, a granular structure having a plurality of protruded spots, a bristled structure having a plurality of bristles and a sectioned structure having a plurality of protruded sections.

10. The vibrating device according to claim 6, wherein the second extending member is made of a material selected from the group consisting of elastic polymeric materials and metals.

11. A vibrating device, comprising:
a base body, having a vibrating motor assembled therein; and
a second extending member, comprising a second shaping portion and a second connecting portion, in which the second shaping portion is disposed opposite to the second connecting portion, the second connecting portion of the second extending member is detachably connected to the base body, one end-face of the base body and the other end-face of the second connecting portion have the same size and the same shape, in which one end-face of the base body and the other end face of the second connecting portion contacts with each other.

12. The vibrating device according to claim 11, wherein the base body is connected to the second extending member via a means selected from the group consisting of threading, locking, engaging and magnetically attracting.

13. The vibrating device according to claim 11, wherein the second shaping portion has a through hole.

14. The vibrating device according to claim 1.1, wherein the second extending member is selected from the group consisting of a bending segment, a ball member, a helix structure, a granular structure having a plurality of protruded spots, a bristled structure having a plurality of bristles and a sectioned structure having a plurality of protruded sections.

15. The vibrating device according to claim 11, wherein the second extending member is made of elastic polymeric materials.

16. The vibrating device according to claim 11, wherein the base body comprises a shell, the vibrating motor is assembled in the shell; the shell is made of rigid material.

17. A vibrating device, comprising:
a base body, comprising a first sleeving end and a second sleeving end opposite to the first sleeving end, the base body having a vibrating motor assembled therein;
a first extending member, approximately formed as elongated shape, comprising a first shaping portion and a first connecting portion, the first shaping portion and the first connecting portion being respectively disposed at two ends of the major axis of the first extending member, the first connecting portion having a first receiving groove formed by recessing the first connecting portion in a direction toward the first shaping portion; and
a second extending member, approximately formed as elongated shaped, comprising a second shaping portion and a second connecting portion, the second shaping portion and the second connecting portion being respectively disposed at two ends of the second extending member, the second connecting portion having a second receiving groove formed by recessing the second connecting portion in a direction toward the second shaping portion;
wherein the first extending member is sleeved onto the first sleeving end of the base body and the second extending member is sleeved onto the second sleeving end of the base body, such that the first sleeving end of the base body is enclosed by the first extending member and the second sleeving end of the base body is enclosed by the second extending member respectively.

18. The vibrating device according to claim 17, wherein a groove opening of the first receiving groove and a groove opening of the second receiving groove are opposite to each other.

19. The vibrating device according to claim 17, wherein the ranges of the depths of the first receiving groove and the second receiving groove are defined between 45 mm to 50 mm.

20. The vibrating device according to claim 17, wherein the range of the wall thickness of one of the first receiving groove and the second receiving groove is defined between 1 mm to 3 mm.

21. The vibrating device according to claim 17, wherein one of the first shaping portion and the second shaping portion is a selected from the group consisting of a bending segment, a ball member, a helix structure, a granular structure having a plurality of protruded spots, a bristled structure having a plurality of bristles and a sectioned structure having a plurality of protruded sections.

22. The vibrating device according to claim 17, wherein one of one end of the first shaping portion and the second shaping portion is an arc curved surface.

23. The vibrating device according to claim 17, wherein one of two ends of the first shaping portion and the second shaping portion are two extruding portions and a second angle is defined between the two extruding portions.

24. The vibrating device according to claim 17, wherein one of the first extending member and the second extending member is made of elastic polymeric materials.

25. The vibrating device according to claim 17, wherein the first extending member further comprises:
a first root unit, having the first shaping portion and the first connecting portion; and
at least one first branch unit, connected to the first root unit, disposed between the first shaping portion and the first connecting portion, and extended toward the first shaping portion.

26. The vibrating device according to claim 17, wherein the second extending member further comprises:
a second root unit, having the second shaping portion and the second connecting portion; and
at least one second branch unit, connected to the second root unit, disposed between the second shaping portion and the second connecting portion, and extended toward the second shaping portion.

27. The vibrating device according to claim 17, wherein one of the first receiving groove and the second receiving groove comprises a plurality of recessed grooves opened on the inner surface thereon.

28. The vibrating device according to claim 27, wherein the recessed grooves are opened toward a center direction.

29. The vibrating device according to claim 27, wherein the recessed grooves are divided into two groups disposed opposite to each other.

30. The vibrating device according to claim 27, wherein channels of the recessed grooves are parallel with each other.
